(19) United States
(12) Patent Application Publication
(10) Pub. No.: US 2016/0286933 A1
(43) Pub. Date: Oct. 6, 2016

(54) TOPICAL SKIN CARE PRODUCT APPLICATOR DEVICE

(71) Applicant: Thomas J. Northcott, Chesterfield, MO (US)

(72) Inventor: Thomas J. Northcott, Chesterfield, MO (US)

(21) Appl. No.: 14/677,347

(22) Filed: Apr. 2, 2015

(51) Int. Cl. A45D 40/26; B43K 8/08

(52) U.S. Cl. CPC A45D 40/262; B43K 8/08

(57) ABSTRACT

An applicator device for applying sunscreen to skin around sensitive areas of a body. A housing stores said sunscreen product. A foam or felt applicator tip is disposed at a first distal end portion of the housing to be used for applying said sunscreen product to the skin around the sensitive areas of the body. Different shapes of applicator tips including chisel, flat, wide, round and fine, and pointed tips are available. A cap is disposed over a first distal end portion of said housing to provide a cover to the applicator tip and prevent the applicator tip from drying out when the applicator device is not in use. A removable end is disposed at a second distal end portion of the housing to enable a user to refill the housing with the sunscreen product when empty and reuse the applicator device.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to personal care items. More particularly, the invention relates to means for applying sunscreen to the skin.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Sunscreen may be used by individuals to help protect their skin from sunburn and other types of skin damage. Some types of sunscreen may do this by absorbing or reflecting a portion of the UV radiation from the sun that reaches the user's skin. Sunscreen may typically be applied topically, and may be made available as lotion, gel, spray, wipes, or other types of topical products. Such approaches may not provide a safe and/or easy way to apply sunscreen around sensitive areas such as, but not limited to, eyes, ears, noses, lips etc.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagrammatic side view of an exemplary sunscreen applicator, in accordance with an embodiment of the present invention;

FIG. 2 is a diagrammatic side view of an exemplary refillable sunscreen applicator, in accordance with an embodiment of the present invention; and

FIG. 3 illustrates multiple exemplary applicator tips for sunscreen applicators, in accordance with some embodiments of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys. Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit —“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

One embodiment of the present invention may provide means for applying sunscreen with a marker type device. In some embodiments the tip of the applicator may be made of hard felt or foam. Some embodiments may provide an easy and safe way to apply sunscreen around sensitive areas such as, but not limited to, eyes, ears, noses, and lips especially in children and babies.

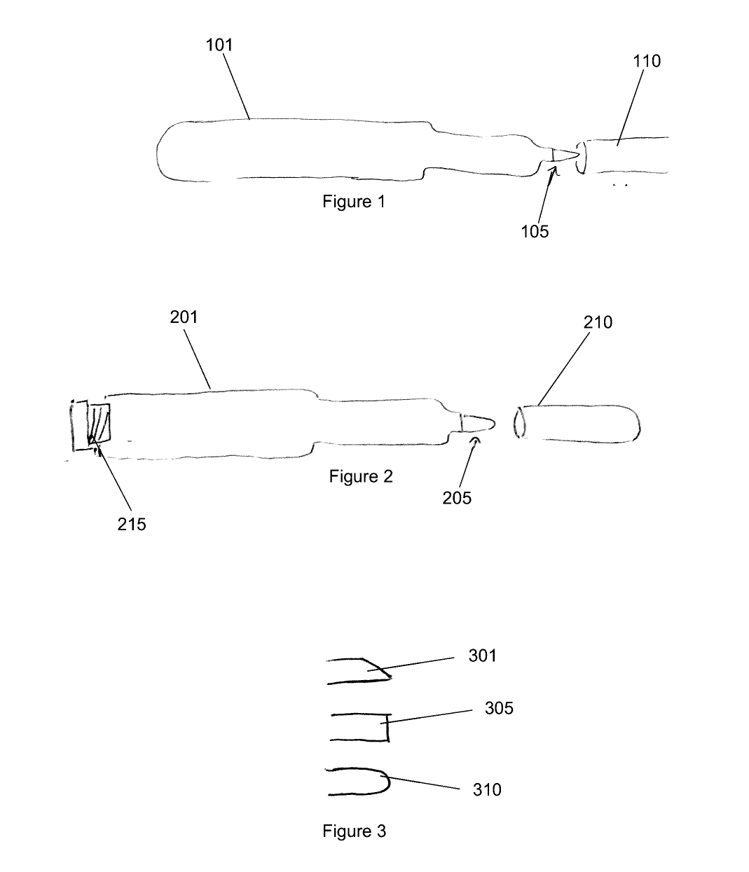

FIG. 1 is a diagrammatic side view of an exemplary sunscreen applicator, in accordance with an embodiment of the present invention. In the present embodiment, the applicator comprises a housing 101 with a reservoir that may be filled with sunscreen. An insert may be placed into the reservoir so that a portion of the insert extends from housing 101 to form an applicator tip 105. This insert may be made of an absorbent material that may enable the sunscreen in the reservoir to wick up the insert to tip 105 with which the sunscreen may be applied to the skin. For example, without limitation, the insert may be made of foam, sponge, felt, cotton, rubber, cork, plastic, roller ball tip, etc. In some alternate embodiments, the tip may be a separate component rather than one end of the wicking insert. For example, without limitation, some embodiments may comprise an insert that wicks the sunscreen up to an applicator tip with a roller ball, similar to a ball point pen. In some embodiments the insert may be a tube that draws the sunscreen toward an applicator tip with gravity. Other embodiments may be implemented without an insert in which the sunscreen may be pushed to the tip with an advancement mechanism or when a user squeezes the housing of the applicator.

In the present embodiment, a cap 110 may be placed over tip 105 to help prevent tip 105 from drying out when the applicator is not in use. Cap 110 may snap or screw onto housing 101, and may be stored on the back portion of housing 101 when the applicator is in use. In some embodiments the cap may not be stored on the back of the housing. For example, without limitation, some embodiments may not comprise means for holding the cap on the back portion of the housing. Other embodiments may comprise different types of caps such as, but not limited to, flip open caps, push button caps, pull off caps, and screw off/on. Yet other embodiments may be implemented without a cap. For example, without limitation, some embodiments may comprise retractable tips so that the tips may be enclosed in the housing of the applicator when not in use rather than being covered by a cap. In the present embodiment, housing 101 and cap 110 may be made of various different plastics or other suitable materials including, without limitation, metals, biodegradable polymers, resins, etc. The sunscreen applicator may typically be prefilled with sunscreen and typically may not be refillable. Some alternate embodiments may be configured to be refillable such as, but not limited to, the embodiment illustrated by way of example in accordance with FIG. 2.

In typical use of the present embodiment, cap 110 may be removed to expose applicator tip 105. A user may then apply sunscreen with the applicator by “writing on” or “coloring” the skin with tip 105 similarly to the way one may write or color with a marker. Due to the size of tip 105, one may expect that it may be easy to apply sunscreen in a defined area, which may enable the user to easily and safely apply sunscreen to difficult to cover and/or sensitive areas such as, but not limited to, around the eyes and mouth, on the ears, along the hairline, etc. Furthermore, the applicator may enable the user to safely apply sunscreen on children and babies in a way that may be fun for the child. In some cases, the children may want to use the applicator themselves. In another contemplated use of the present embodiment, users may apply sunscreen to their skin in order to create temporary “tan tattoos”. For example, without limitation, a user may use the applicator to write on or draw pictures or designs on their skin and/or the skin of others. Since the area where the sunscreen has been applied typically does not burn or tan, the words or designs drawn on the skin will typically be lighter than the surrounding skin to which the sunscreen was not applied, thus creating an image that may remain on the skin temporarily. Some embodiments of the present invention may be used before and/or during virtually any outside activity to help protect skin against sun damage. In addition, some embodiments may be inexpensive and as wall as easy to store and transport.

FIG. 2 is a diagrammatic side view of an exemplary refillable sunscreen applicator, in accordance with an embodiment of the present invention. In the present embodiment, the applicator comprises a housing 201 with an applicator tip 205 and a removable cap 210. A reservoir for sunscreen may be included without limitation in housing 201. A removable end 215 may enable a user to refill the reservoir and reuse the applicator. This may also enable the user to use virtually any sunscreen they wish with the applicator. Removable end 215 may be able to screw on and off of housing 201. In some alternate embodiments the removable end may attach to the housing using a multiplicity of suitable means including, without limitation, a snap on attachment, by sliding snugly into the housing, hinged and flip open attachment means, etc. In other alternate embodiments various different portions of the housing may be opened or removed to enable a user to refill the reservoir. For example, without limitation, the tip may be removable or the housing may comprise means for being separated near the middle of the applicator such as, but not limited to, a threaded connection. It is contemplated that refillable embodiments may be available to end users in prefilled versions and empty versions. Some alternate embodiments may be implemented to accept prefilled cartridges rather than accepting sunscreen directly into a reservoir.

FIG. 3 illustrates multiple exemplary applicator tips for sunscreen applicators, in accordance with some embodiments of the present invention. The embodiments described by way of example, in the foregoing, comprised pointed applicator tips 105 and 205. It is contemplated that applicator tips of various different shapes may be implemented on some embodiments including, without limitation, chisel shaped tips 301, flat tips 305, rounded tips 310, fine tips (not shown), etc. Furthermore, in some embodiments the applicators may comprise tips of various different sizes ranging, for example, without limitation, from fine point to jumbo sized. The availability of tips of different shapes and sizes may allow for sunscreen to be applied in different ways. For example, without limitation, large, flat tips may be used to apply sunscreen to large areas of the skin while fine pointed tips may be used to apply sunscreen to sensitive areas or to draw intricate designs on the skin. Some alternate embodiments may comprise specialty tips shaped in decorative designs such as, but not limited to, hearts or stars that may be stamped onto the skin.

Those skilled in the art will readily recognize, in light of and in accordance with the teachings of the present invention, that a multiplicity of suitable means may be used to advance the sunscreen toward the tip of the applicator. For example, without limitation, one embodiment may comprise a thumb “pump” such as, but not limited to, a squeezable portion of the housing to enable a user to “pump” more sunscreen onto the tip. Alternate embodiments may comprise plunger mechanisms that may be advanced by push buttons, twistable knobs, levers, etc. Other alternate embodiments may comprise, without limitation, may instead achieve advancing the sunscreen by providing a squeezable body that the user may squeeze as much sunscreen to the target point; or, a push button may be configured into applicator for pressing/pumping more sun screen into the applicator. It is contemplated that some embodiments may be made by manufacturers and marketers of sunscreen, and other embodiments may be manufactured by an entity other than a sunscreen manufacturer and later combined with a sunscreen product by a sunscreen manufacturer or an end user. It will be further apparent to those skilled in the art that various different or additional features may be included without limitation on some embodiments such as, but not limited to, clips for attaching the applicator to clothing or bags, attachment straps or cords, colored sunscreen, an ergonomic shape, a textured or rubberized area for enhanced grip, a waterproof housing, etc. Furthermore some alternate embodiments may be implemented for the application of substances other than sunscreen such as, but not limited to, moisturizing lotions, make up, perfume, body oil, etc.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing means for applying sunscreen to the skin according to the present invention will be apparent to those skilled in the art. Various aspects of the invention have been described above by way of illustration, and the specific embodiments disclosed are not intended to limit the invention to the particular forms disclosed. The particular implementation of the means for applying sunscreen may vary depending upon the particular context or application. By way of example, and not limitation, the sunscreen applicators described in the foregoing were principally directed to implementations comprising single application tips; however, similar techniques may instead be applied to applicators with multiple application tips and interchangeable application tips, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An applicator device comprising:
a housing, said housing comprises a reservoir, in which said reservoir is configured to be capable of holding or storing a topical product for skin application, wherein said topical product comprises a skin care topical product operable for generally protecting the skin from damage when exposed to environmental elements;
an applicator tip, said applicator tip is generally disposed at a first distal end portion of said housing, in which said applicator tip comprises a foam or felt applicator tip, wherein said applicator tip is operable to provide a substantially safe and easy way to apply said skin care topical product to the skin around sensitive areas of a body that is exposed to said environmental elements, in which said sensitive areas of the body includes eyes, ears, noses and lips;
a cap, said cap is configured to be generally disposed over said first distal end portion of said housing, in which said cap is further configured to substantially cover said applicator tip, wherein said cap is operable to generally prevent said applicator tip from drying out when said applicator device is not in use;
a removable end, said removable end is generally disposed at a second distal end portion of said housing, wherein said removable end is operable for enabling a user to refill said reservoir with said skin care topical product and reuse said applicator device.

2. The device of claim 1, in which said skin care topical product comprises a sunscreen, wherein said sunscreen is operable to generally absorb or reflect a portion of sun UV radiation that reaches a user's skin, and in which said skin care topical product further comprises lotion, gel or spray.

3. The device of claim 2, in which said housing further comprises an insert, wherein said insert is configured to substantially extend from said second distal end portion of said housing to said first distal end portion of said housing.

4. The device of claim 2, in which said housing further comprises an insert, said insert is configured to substantially extend from said second distal end portion of said housing to said first distal end portion of said housing, wherein a portion of said insert generally forms said applicator tip.

5. The device of claim 4, in which said insert comprises an absorbent material configured to enable said sunscreen product in said reservoir to substantially wick up to said applicator tip.

6. The device of claim 5, in which said insert comprises a foam, sponge, felt or cotton operable to substantially wick up said sunscreen product to said applicator tip.

7. The device of claim 2, in which said applicator tip comprises a pointed applicator tip, wherein said pointed applicator tip is operable to provide a substantially safe and easy way to apply said sunscreen product around said sensitive areas, in which said pointed applicator tip is further operable to draw intricate designs on the skin.

8. The device of claim 1, in which said applicator tip comprises a rounded applicator tip, wherein said rounded applicator tip is operable to provide a substantially safe and easy way to apply said topical product around said sensitive areas.

9. The device of claim 1, in which said applicator tip comprises a chisel shaped applicator tip, wherein said chisel shaped applicator tip is operable to provide a substantially safe and easy way to apply said topical product around said sensitive areas.

10. The device of claim 2, in which said applicator tip comprises a flat applicator tip, wherein said flat applicator tip is operable to provide a substantially safe and easy way to apply said sunscreen product to large areas of the skin.

11. The device of claim 1, in which said applicator tip comprises specialty applicator tips, said specialty applicator tips comprise of decorative design shapes, and in which said decorative design shapes comprise of hearts or stars configured to stamp said skin care topical product onto the skin.

12. The device of claim 2, in which said housing further comprises a plastic housing, and in which said housing further comprises a thumb pump, said thumb pump is disposed at a distal end of said housing and comprises a squeezable portion configured to enable a user to pump said sunscreen product toward said applicator tip.

13. The device of claim 2, in which said housing further comprises a tube, wherein said tube is configured to draw said sunscreen product toward said applicator tip with gravity.

14. The device of claim 2, in which said removable end is configured to screw on and off said second distal end portion of said housing, enabling a user to refill said reservoir with said sunscreen product and reuse said applicator device.

15. The device of claim 15, in which said cap comprises a snap cap, said snap cap is configured to snap onto said first distal end portion of said housing, wherein said snap cap is operable to cover said applicator tip and prevent said applicator tip from drying out when said applicator device is not in use, and wherein said cap is further operable to be disposed on a back portion of said removable end when said device is in use.

16. The device of claim 15, in which said cap comprises a flip open cap, push button cap or pull off cap, said cap is configured to snap onto said first distal end portion of said housing, wherein said cap is operable to cover said applicator tip and prevent said applicator tip from drying out when said applicator device is not in use, and wherein said cap is further operable to be disposed on a back portion of said removable end when said device is in use.

17. The device of claim 1, wherein said cap is configured to screw onto said first distal end portion of said housing, wherein said cap is operable to cover said applicator tip and prevent said applicator tip from drying out when said applicator device is not in use.

18. An applicator device comprising:
a housing, said housing comprises a reservoir, in which said reservoir is configured to be capable of storing a sunscreen product operable for protecting the skin from damage when exposed to environmental elements, wherein said sunscreen product is operable to generally absorb or reflect a portion of a sun UV radiation that reaches a user's skin, and in which said sunscreen product comprises lotion, gel or spray;
an applicator tip, said applicator tip is generally disposed at a first distal end portion of said housing, in which said applicator tip comprises a foam or felt applicator tip, wherein said applicator tip is configured to provide a substantially safe and easy way to apply said sunscreen product around sensitive areas of a body;
a removable end, said removable end is generally disposed at a second distal end portion of said housing, in which said removable end is configured to screw on and off said second distal end portion of said housing, wherein said removable end is operable for enabling a user to refill said reservoir with said skin care topical product and reuse said applicator device;
a cap, said cap is configured to be disposed over said first distal end portion of said housing and configured to substantially cover said applicator tip, in which said cap comprises a snap cap, flip open cap, push button cap or pull off cap, wherein said cap is operable to generally prevent said applicator tip from drying out when said applicator device is not in use, and wherein said cap is further operable to be disposed on a back portion of said removable end when said device is in use;
an insert, said insert substantially extends from said second distal end portion of said housing to said first distal end portion of said housing and configured to substantially engage with said applicator tip, in which said insert comprises a foam, sponge, felt or cotton operable to substantially wick up said sunscreen product to said applicator tip.

19. The applicator device of claim 18, in which said applicator tip comprises a pointed, rounded, fine point, flat or chisel shaped applicator tip, wherein said applicator tip is operable to provide a substantially safe and easy way to apply said sunscreen product around said sensitive areas of the body that is exposed to said sun UV radiation, in which said sensitive areas of the body includes eyes, ears, noses and lips.

20. An applicator device for safely and easily applying sunscreen product to skin around sensitive areas of a body comprising:
means for storing said sunscreen product, said sunscreen product is operable to protect the skin from damage when exposed to environmental elements;
means, disposed at a first distal end portion of said storing means, for applying said sunscreen product around said sensitive areas of the body that is exposed to said environmental elements, in which said sensitive areas of the body includes eyes, ears, noses and lips;
means, disposed at a second distal end portion of said storing means, for refilling said means for storing with said personal skin care topical product and reuse said applicator device;
means, disposed over said first distal end portion of said storing means, for preventing said applicator tip from drying out when said applicator device is not in use;
means, disposed over said first distal end portion of said storing means, for holding said preventing means when said device is not in use;
means, disposed at a back portion of said refilling means, for holding said preventing means when said device is in use;
means for wicking up said sunscreen product to said applying means.
